(19) United States
(12) Patent Application Publication
(10) Pub. No.: US 2023/0037185 A1
(43) Pub. Date: Feb. 2, 2023

(54) METHOD AND APPARATUS FOR CROWD-SOURCING DETERMINATIONS OF INFORMATION VERACITY

(71) Applicant: CROWDSOURCE TRUTH LLC, Norwalk, CT (US)

(72) Inventors: JOHN M. PACKES, JR., NORWALK, CT (US); MICHAEL PATTERSON, MT. VERNON, NY (US); CHARLES ARTHUR RATTNER, STAMFORD, CT (US)

(21) Appl. No.: 17/836,818

(22) Filed: Jun. 9, 2022

Related U.S. Application Data
(63) Continuation-in-part of application No. 16/001,484, filed on Jun. 6, 2018, now abandoned.
(60) Provisional application No. 62/515,998, filed on Jun. 6, 2017.

(51) Int. Cl. G06Q 50/00; G06F 3/0484

(52) U.S. Cl. CPC G06Q 50/01; G06F 3/0484

(57) ABSTRACT

Software-based network tools are introduced for democratizing public opinion by enabling readers to crowd-source the truth of any digital content, from printed news to radio and video transcripts, scholarly articles, legislative bills and any other content available over a computer network. Instant user-driven voting analytics highlight fake news and spotlight specious and malicious claims by any individual, organization, or other publisher/author.

### CROSS-REFERENCE TO RELATED APPLICATIONS

This application claims priority under 35 U.S.C. § 120 as a continuation-in-part of pending U.S. patent application Ser. No. 16/001,484 entitled “METHOD AND APPARATUS FOR CROWD-SOURCING DETERMINATIONS OF INFORMATION VERACITY” filed in the name of Packes, Jr. et al. on Jun. 6, 2018, which in turn claims priority under 35 U.S.C. § 119(e) to U.S. Provisional Patent Application Ser. No. 62/515,998 entitled “METHOD AND APPARATUS FOR CROWD-SOURCING DETERMINATIONS OF INFORMATION VERACITY” filed in the name of Packes, Jr. et al. on Jun. 6, 2017, the entirety of which is herein incorporated by reference.

### TECHNICAL FIELD

This disclosure generally relates to data processing, and in particular it relates to collaborative document database management.

### BACKGROUND OF THE DISCLOSURE

A generation on from the Cronkite era of widely-trusted reporting, and in the aftermath of the Fairness Doctrine being abandoned by the Federal Communications Commission and media conglomeration being allowed to proliferate, nowadays, anyone can seemingly make any outrageous claim, which may then be picked up and spread virally on social media sites, the Internet and the like. Freedom of speech has unfortunately become unmoored from responsibility for truthful speech. Fake news has become news itself, and people are left confused about what's true. The consequences are enormous. Pivotal European elections are underway, the U.S. elections are not far off, and funding for cornerstone initiatives such as climate change and scientific research are threatened. Public sentiments on these and other topics have been demonstrably affected in the past by the dissemination of conflicting, and sometimes untruthful, information.

The Internet has provided universal access to information in real-time, but its sheer volume, and the open license for anyone to write anything, has left readers unable to distinguish fact from fiction. This inability has polarized the web, where readers' political views dictate which sites they gravitate, to the point where many people largely insulate themselves from other perspectives and arguments. Accordingly, there is a need for determining the veracity of distributed information, which is accessible to the bulk of content consumers.

### SUMMARY OF THE DISCLOSURE

With the Internet Crowdsource-Based System (ICBS) now introduced, it's the people's turn to crowd-source truth, and ensure that pervasive falsehoods are identified and flagged for truth/falsity prior to presentation to other users.

Disrupting the sanctity of original digital content, while respecting expression as a cornerstone of democracy, ICBS enables anyone to respond to the veracity of what they read online through voting, for example, “Truth” or “Untrue,” (sometimes abbreviated herein as BS), and to debunk dubious claims with citations and counter-arguments, all within and beside the original, undisturbed content. Each vote and comment thereon provides a potential anchor for a unique thread addressable by a plurality of users. With ICBS, authors from across the political spectrum, in particular, will be held accountable for what they write.

In one example, a trending news article is read by five thousand people using ICBS within a week. They've highlighted factual claims and judged them True or BS, yielding instant polling results. They've also embedded comments and any supporting citations. Meanwhile, ICBS code constantly provides an ever-updated summary of responses in an easy-to-digest dashboard. As ICBS users infuse online digital content with their own knowledge and opinions, they build infinite, searchable depth into original documents for the benefit of others, and for the integrity and democratization of history itself.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is an illustration of a network environment in which the methods and apparatus of the present disclosure may be operative;

FIG. 2 is an exemplary display of digital content as may be presented on a user device of FIG. 1, including an ICBS functionality toolbar;

FIG. 3 is an exemplary display of icons and buttons that may be presented on the ICBS toolbar of FIG. 2;

FIG. 4 is an exemplary display of color-coding scale (“heat map”) applied to digital content based on ICBS user votes, and voting buttons that may be used on the ICBS toolbar of FIG. 2;

FIG. 5 is an exemplary display of submit buttons, processing icons and back and cancel buttons on the ICBS toolbar of FIG. 2;

FIG. 6-11 are exemplary displays of first digital content with ICBS voting and results reporting functionality displayed therewith; and

FIG. 12-22 are exemplary displays of second digital content with ICBS voting and results reporting functionality displayed therewith.

### DETAILED DESCRIPTION OF THE SPECIFIC EMBODIMENTS

To democratize public opinion, ICBS enables readers to enter a vote on the veracity of content being viewed on a computer network via their user devices with an ICBS user interface (UI). The UI thus allows users to navigate to addressed digital content and then select all or a portion thereof (via a mouse drag and select function or the like) for voting thereon. Users thereby crowd-source the truth of any digital content or portion thereof, comment on any opinion, and insert citations, all displayed within and beside the content via the ICBS UI. Instant user-driven analytics will highlight fake news and spotlight specious and malicious claims by any individual, organization, or government. As digital content becomes ICBS-rated, the votes can be used as ‘proof references’ for other articles. Highly rated documents earn trust badges; poorly rated files are side-lined. Like doctors and hospitals or professors and universities, authors and publishers can now be compared in precisely democratic ways.

Among limitless applications, users can collectively distill digital content, such as a news article, a book, or an environmental impact statement, or any portion thereof, such as a sentence of paragraph, to its core content, strengths, and deficiencies, so as to greatly improve reading efficiency and desirability. Anything can be accurately rated, from common myths like an apple a day, to TV shows and films, to best athlete and best acting debates, to whether the nation should go to war. To reflect changing views, ICBS users can revisit and revise their factual judgments and text edits at any time.

A browser, browser plug-in, mobile app and/or web portal provided by ICBS has clear potential to become the internet's top rating tool. Such tools represent an improvement in computer programming and computerized network communications, which introduce the novel functionalities described herein, and which heretofore, have been unavailable in existing technologies including generic computer processing systems. ICBS is a voluntary, internet-wide, real-time, unimpeachable poll that highlights trends as they happen. ICBS' democratic and demographic breadth, depth, and granular precision, in novel application to web content, will prove surpassingly valuable to reader trust and comprehension upon launch, and to the future of all research.

ICBS is an entirely new platform that is adaptable for all languages, with obvious potential to seed new literary review forms. This new people's power, bound to drive public-policy as well as art, means the end of the old media order.

At its most basic level, ICBS enables audiences to rate the truthfulness of any media claim by voting “Truth” or “BS”. ICBS technology aggregates the feedback and generates analytical statistics based on user activity. In addition, ICBS allows users to cite sources for their votes. A dashboard presented with the content summarizes results and facilitates drill-down of user viewpoints.

ICBS functionality allows users to turn ICBS off completely, on for selected articles or documents, or always on. In the Off position, ICBS lies dormant. In the On positions, based on proprietary ICBS algorithms as disclosed herein, all text that has been voted on by previous readers is highlighted in shades of green when such content is viewed on an ICBS enabled user device. If crowdsourced as truthful the content may be graphically highlighted, such as shades of green based on user voting on the content. Alternately, shades of red may be assigned to the content or portion thereof if a majority of users call it untruthful (BS). Accordingly, ICBS visually represents the audits, knowledge, and opinions of potentially millions of other readers sequentially layered and fully searchable into a single original document.

ICBS users can set truth baselines for newsfeeds, for example at 80% to receive only news that's at least 80% crowd-verified. Users can also read entire articles with color-coded text representing collective Truth and BS ratings, and meters showing demographic and political preferences behind every vote, comment, citation, and edit. Through the use of ICBS tools, users will soon learn to read and comprehend color-coded verification layers at the same rates we normally read.

Readers can both contribute to and receive crowd-distilled articles for quick perusal, so in just seconds absorb the core truths of full-length pieces. Programming is provided to revert to original documents at any desired time. Peers can opt to follow one another based on Truth or BS choices. ICBS algorithms generate constant tickers for “What's Trending,” “Highest Truth Ratings,” “Highest BS Ratings,” and the like.

In various embodiments, ICBS users can channel any live audio or video broadcast, such as a State of the Union address, and join others in calling Truth or BS on any claim therein in real time. As with articles, graphical meters instantly report user feedback for all to see.

ICBS profiles are completed by selecting interests and skills, with optional profile categories such as gender, age category, nationality, race, and scale-based (e.g., 1-10) political identification. Profiles may also include photos, references to educational attainment and professional positions held, and proof of authorship or other creative work. Users may choose to remain anonymous so long as they meet minimum standards for personal authentication.

Authors and media outlets must opt to open-source their copyright through ICBS, which in no way intends to threaten existing copyrighted material. ICBS will immediately practice best protections for those who wish to retain privacy or copyright protections, while building needed structure and motive in the open source world.

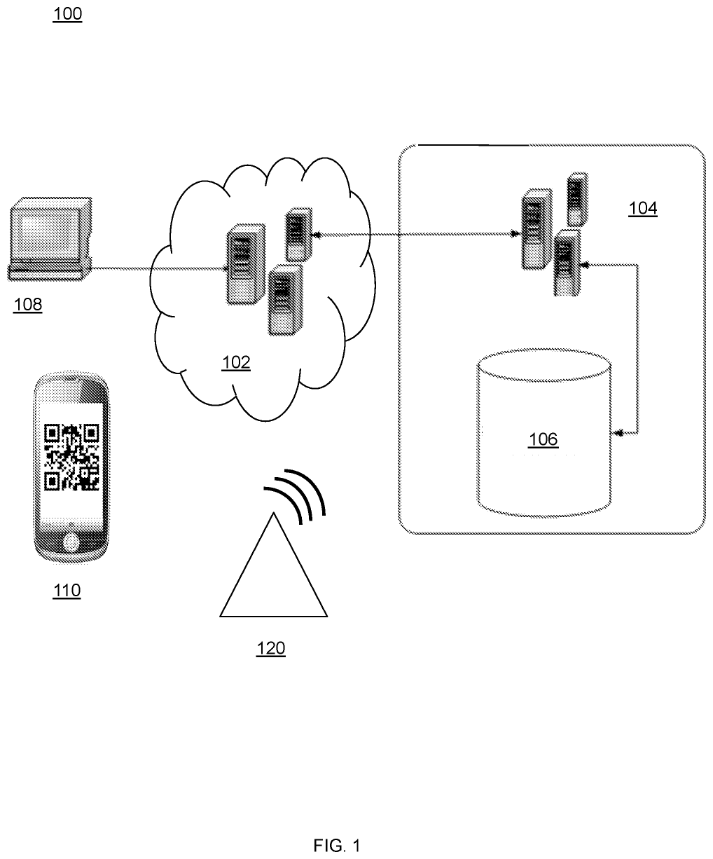

Turning to FIG. 1, therein is depicted an illustration of an exemplary data communication network environment 100 over which user devices may interact with each other and the ICBS website. The ICBS server(s) 104 are one hub of the network environment 100, the special programming of which as described herein enables user computer devices 108 and/or user mobile devices 110 to interact as described herein over a data communication computer network, such as the Internet. The ICBS server(s) 104 may be one or a group of distributed or centralized network computer servers. Such servers, like any common personal computer, include well-known processors, electronic memory, network communication hardware, user interfaces, input/output devices, operating system software, and application software suitable for accomplishing the functions described herein. A suitable computer server may be one or more enterprise network servers of the type commonly manufactured by CISCO, DELL and IBM. The ICBS server(s) 104 may be configured to perform the functionalities described herein through suitable programming in C++, PHP, JAVASCRIPT or the like, and may include at least one database 106 for storing the data described herein and database management software, for example, similar to the Structured Query Language (SQL)-type databases distributed by ORACLE. The ICBS server(s) 104 may be centrally located or may be distributed among a variety of geographical locations, and may cooperate to enable the functions described herein. The ICBS server(s) 104 may act as a “cloud” service to a plurality of users.

Users will typically maintain an account with the operator of the ICBS server(s) 104. Such account will be registered with the ICBS system. The identity of each user may be verified and authenticated in any of a plurality of known manners. In addition to user account information, personal profile information and monetary amounts due for subscribing to this service may likewise be stored in ICBS databases 106.

Computing devices 108 may be one or more separate consumer computing devices that are operative to communicate data bi-directionally with the ICBS server(s) 104 over a computer network, such as the Internet. The computing devices 108 may be owned and operated by separate and distinct users. Users may be assigned a login to access the ICBS server(s) 104. When interacting with the ICBS server(s) 104 over the Internet, a display of the computing device 108 may be changed and updated to enable the user devices to directly interact with the ICBS server(s) 104 in the manners described herein. In particular, a browser, a browser plug-in or a website portal may be provided by the ICBS server(s) 104 to view and interact with addressed content on the computer network, and to interact with the content, or portions thereof as described herein.

Computing devices 108 may be any suitable computing or communication device used to accomplish the processes described herein. A computing device 108 may be, for example, a personal computer, laptop computer, notebook computer, mobile telephone, smartphone, tablet, personal digital assistant or like device of the type commonly manufactured by IBM CORP, DELL CORP. and APPLE CORP., and having suitable operating system software (i.e., WINDOWS XP, WINDOWS 8, WINDOWS 10, MAC OS X, SUN OS), application software, visual displays, processors, electronic memory, network communication hardware, user interfaces (such as a visible display), and other suitable input/output devices, as are well-known and suitable for accomplishing the functions described herein.

The network environment 100 includes one or more network interface servers 102, that coordinate communications between user computing devices 108, user mobile devices 110 location determination devices 120 and the ICBS server(s) 104. The network interface servers 102 may also include addressed content that is viewable by the plurality of users. In certain embodiments, the network environment 100 is implemented over a publicly-accessible computer network, such as the Internet or World Wide Web, via network interface servers 102, which may be any type of server mentioned above. The disclosure is not limited to implementation in any specific network configuration.

The wireless access devices 120 allow user devices, such as computer and mobile devices to access the network environment 100 from a remote location. The wireless access devices 120 are readily contemplated to include the use of any wireless and/or hard-wired devices operating in conjunction with satellite, microwave, fiber optic, copper, local area networks (LANs), wide-are networks (WANs), WIFI, IEEE 802.11-based protocols, WIMAX and/or other network configurations. The wireless access devices may likewise include Bluetooth or WI-FI beacons, GPS geo-fencing systems, near-field proximity detectors, radio-frequency identification (RFID) tags for determining a location of the user device or the like.

The network environment 100 may be implemented in any type of system comprising interconnected computers configured to communicate data with each other using messages transmitted electronically or via other means, without limitation. Data may be transmitted between the computers, devices and servers shown in FIG. 1 using any of the variety of data formats including, but not limited to, Hypertext Transfer Protocol (HTTP), file transfer protocol (FTP), or any other suitable data transmission protocols. Data transmissions may also be encrypted with any of a variety of known technologies, including secure socket layer (SSL) topologies.

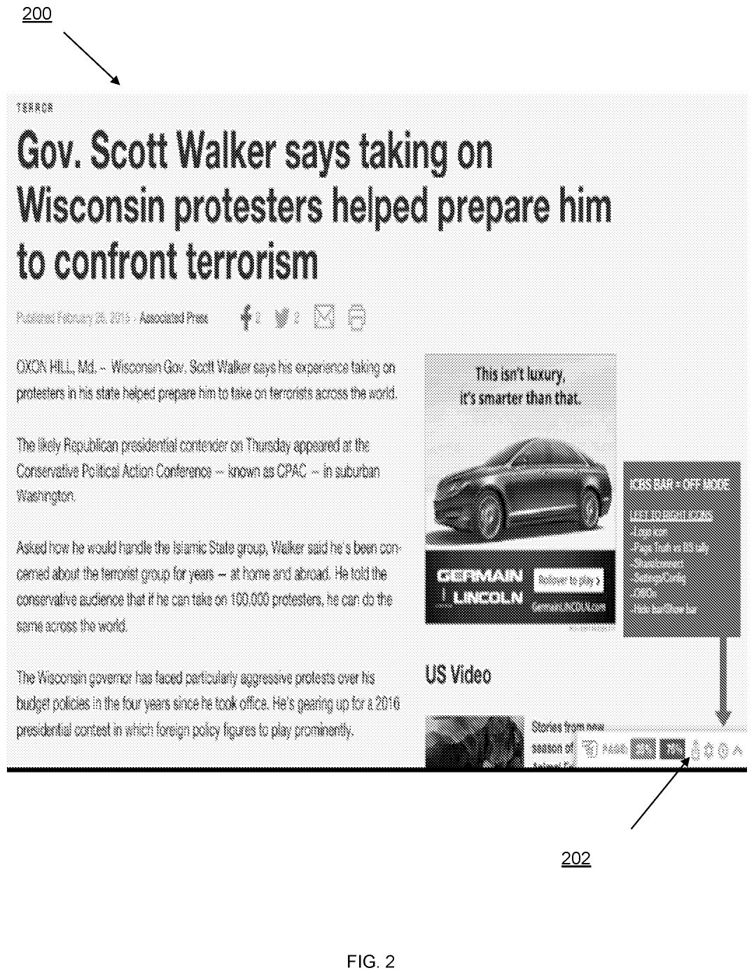

FIG. 2 is an exemplary display of digital content 200 as may be presented on a user device of FIG. 1, including an ICBS functionality toolbar 202. The possible functions associated with the ICBS toolbar 202 are discussed in further detail herein. As displayed, the ICBS toolbar 202 is in the off mode. The ICBS toolbar 202 may include the following functions, with associated buttons for their activation: ICBS logo, Current Truth v. BS rating based on user votes, a share/connect button for sharing the content with another designated user, an on/off button for turning on ICBS functionality for the displayed content, and a hide/show button for hiding or showing ICBS data for the content and/or activating/deactivating the ICBS toolbar 202.

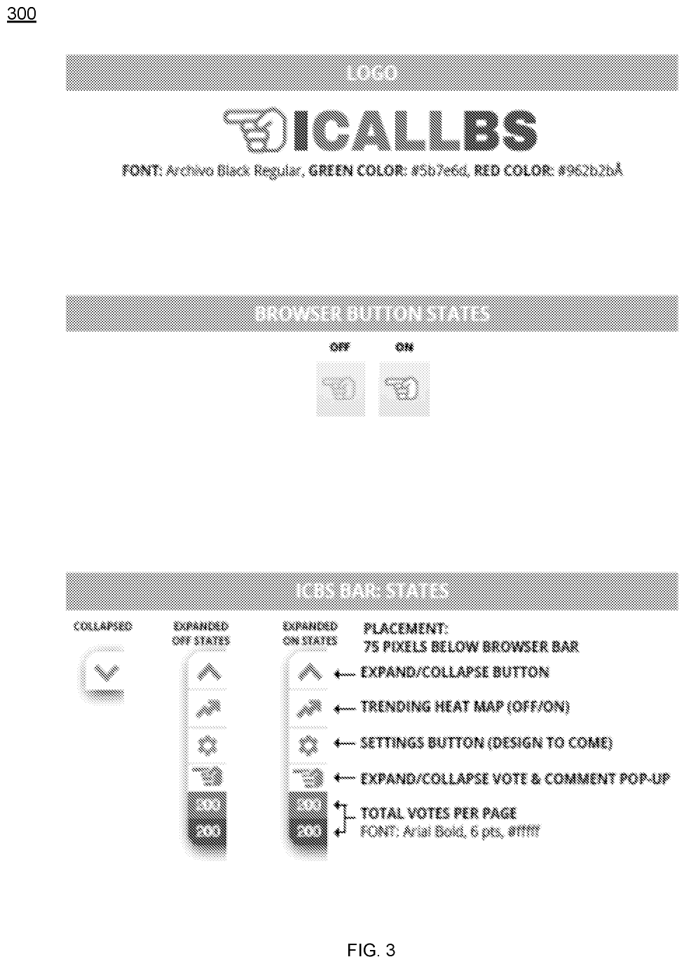

FIG. 3 is an exemplary detailed display of further icons and buttons that may be presented on the ICBS toolbar 202 of FIG. 2. These may include a logo representing ICBS, browser button states (on and off), and ICBS toolbar buttons. The ICBS toolbar buttons may include, but are not limited to: an expand/collapse button for expand or collapsing the display of ICBS functions, a trending heat map button for toggling the display of color-shading of content based on truth v. BS votes of the users, a settings button for changing various ICBS settings, and expand/collapse vote and comment button for expanding or collapsing the display of ICBS vote tallies relating to the content, and an indicator of total truth and BS votes received for the displayed content.

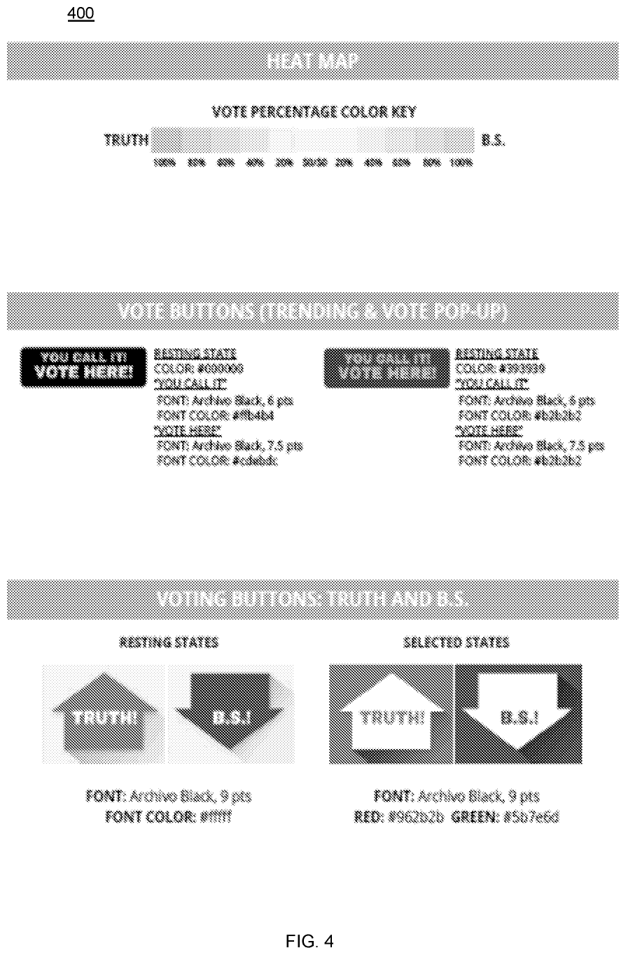

FIG. 4 is an exemplary display of color-coding scale (“heat map”) applied to digital content based on ICBS user votes, and voting buttons that may be used on the ICBS toolbar of FIG. 2. The heat map spectrum is applied to content or a portion thereof based on truth v. BS votes that are received therefor. In various embodiments, the spectrum may range from green to red with various shades thereof in-between. For example, if content receives 100% Truth votes, that content will be displayed in dark green. Content receiving substantially 80% Truth votes will be a lighter shades of green. Content receiving 50% Truth votes and 50% BS votes will be displayed in orange (a mix of red and green). Content with 25% Truth votes will be displayed in light red. Content with 100% BS votes will be displayed in dark red. Other colors or a grayscale may likewise be used. Buttons are provided to vote on the content as well, with for example, a truth button representing a Truth vote and a BS button provided for a False vote being provided in various forms. Alternatively, or in addition thereto, the users may be provided an opportunity to vote incrementally, such as “Mostly True” or “Mostly BS” or the like.

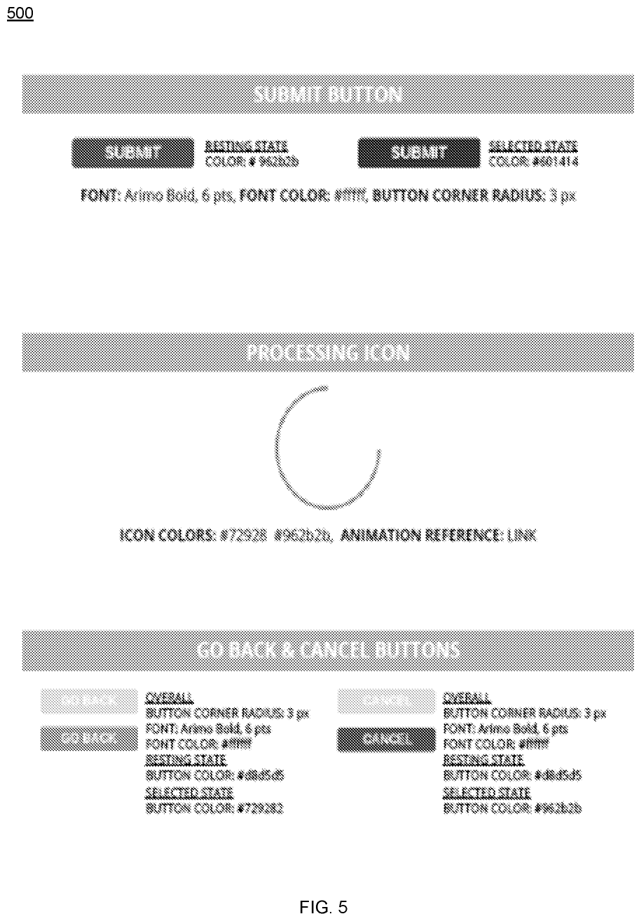

FIG. 5 is an exemplary display of submit buttons (for submitting a vote, comment or annotation for the content), processing icons (to be displayed when submitted information is being processed by the ICBS server(s) 104) and back and cancel buttons (for undoing a previous button-activated function) on the ICBS toolbar of FIG. 2.

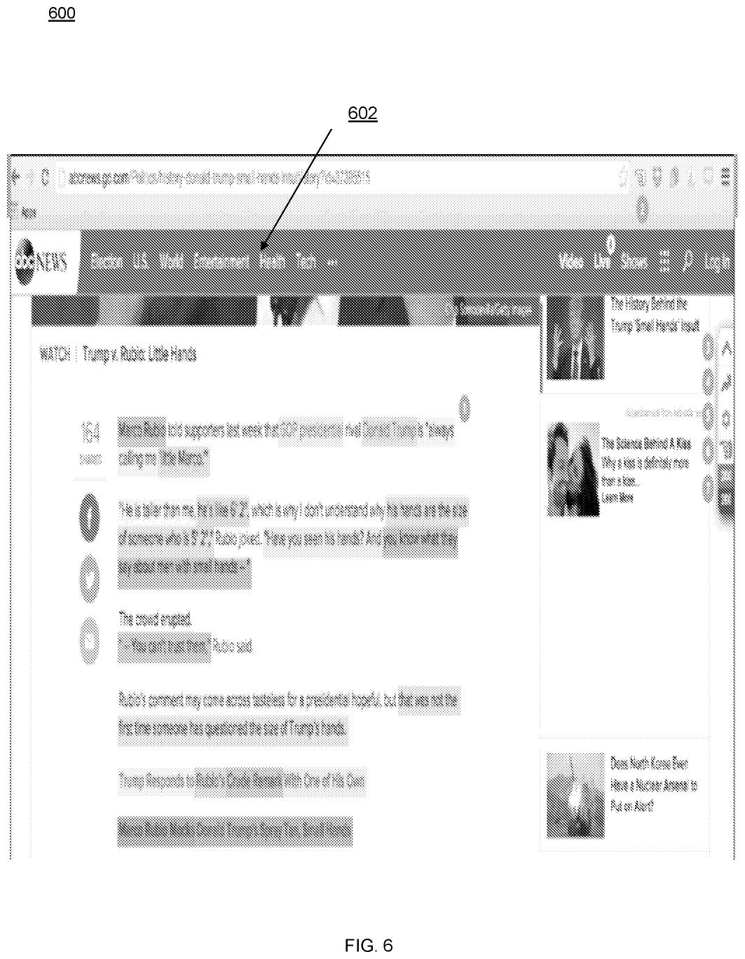

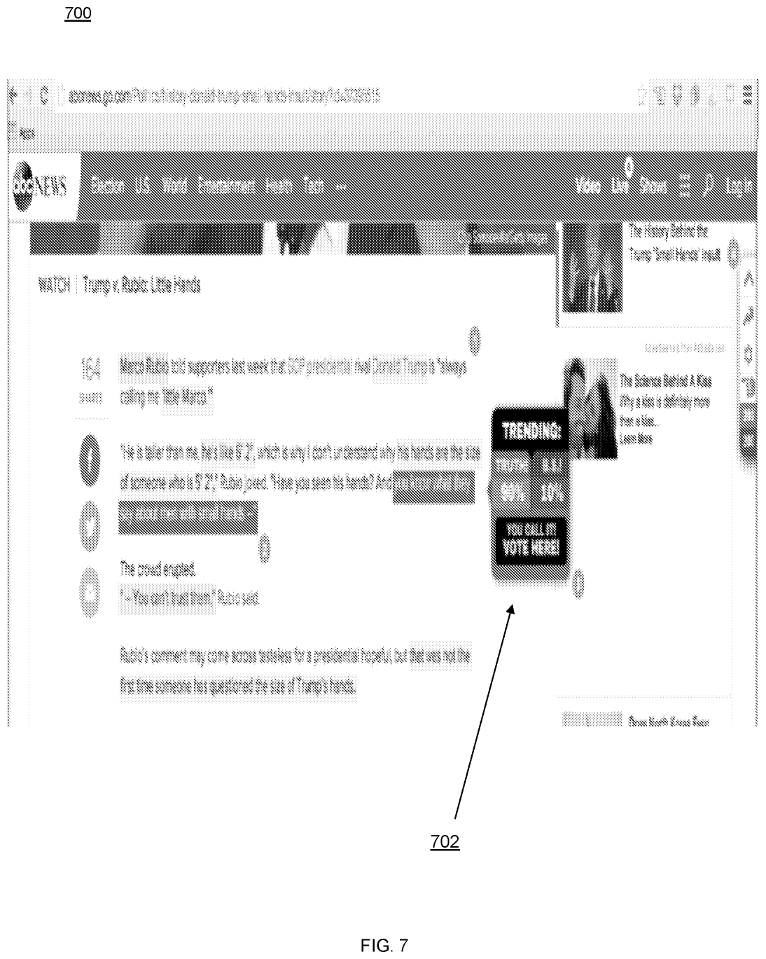

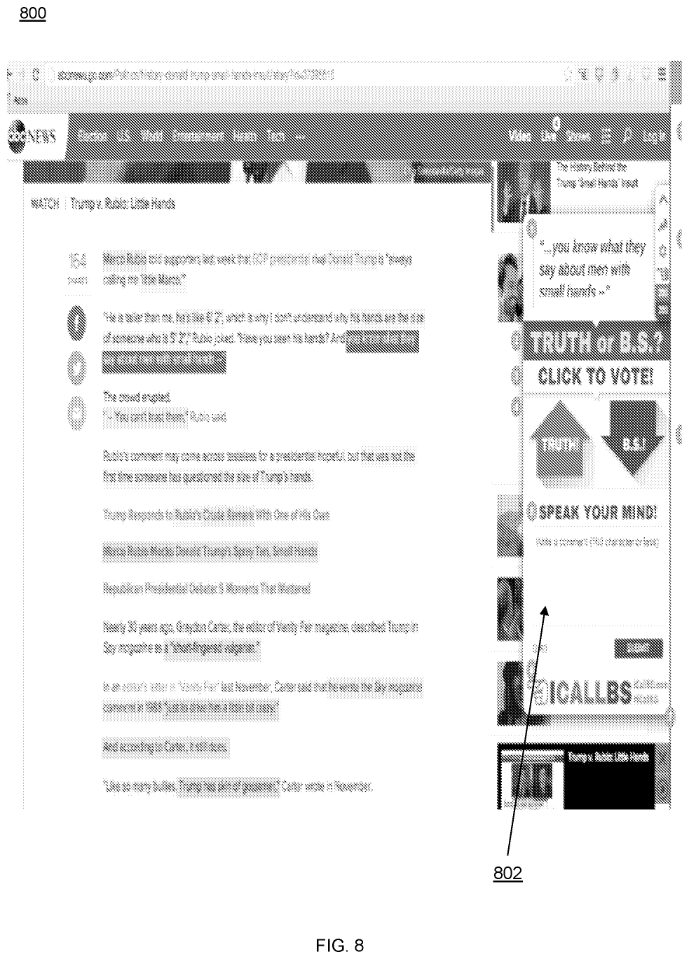

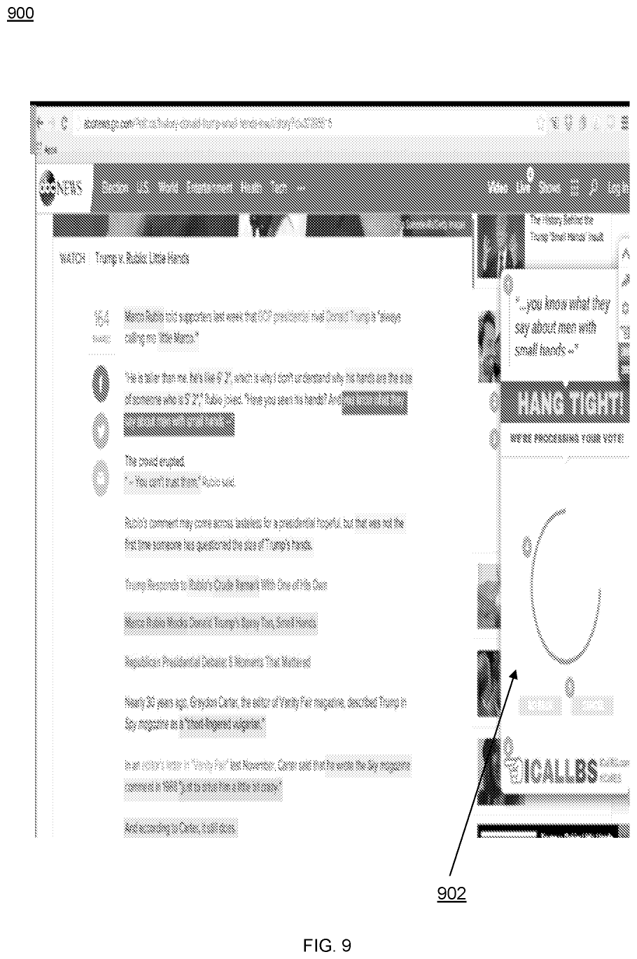

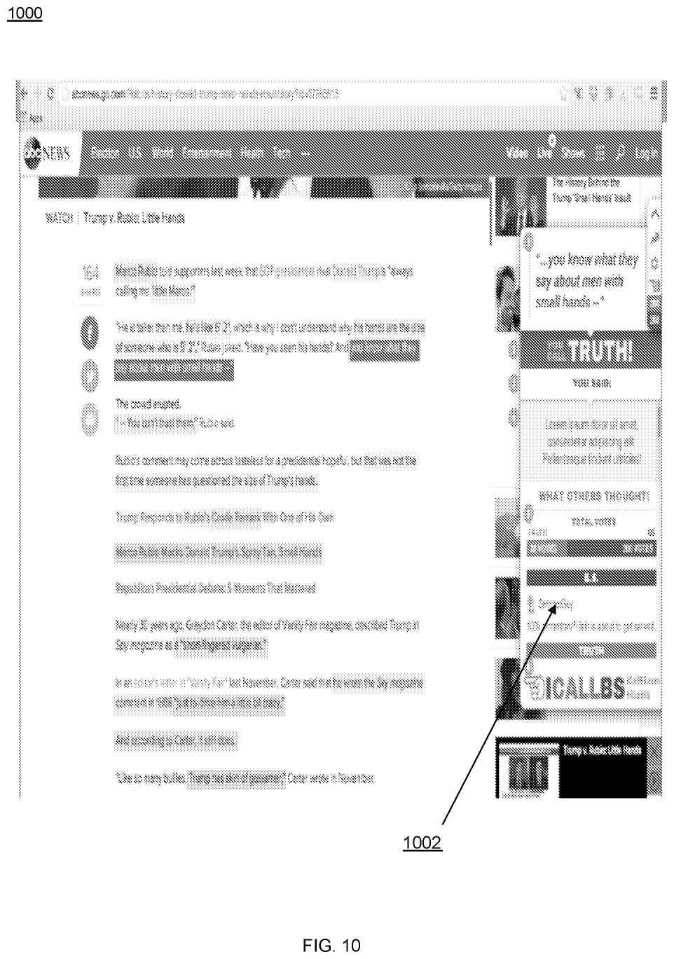

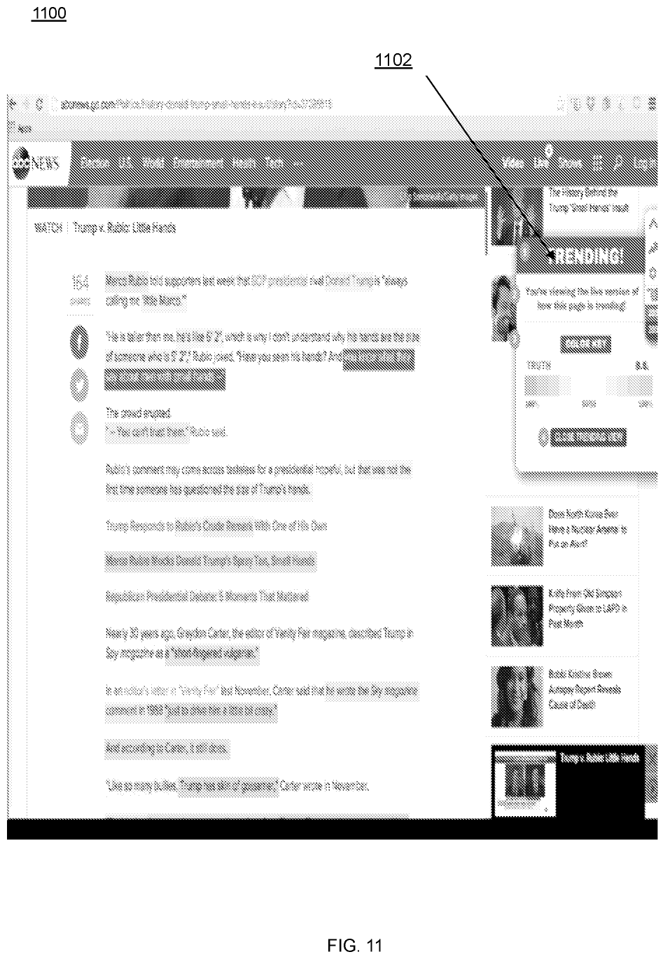

FIG. 6-11 are exemplary displays of first digital content 600-1100 with ICBS voting and results reporting functionality displayed therewith. FIG. 6 shows first digital content with ICBS heat map overlays presented thereon representing the Truth v. BS votes submitted therefor by ICBS user devices. The ICBS toolbar 202 presented therein appears on the upper left portion of the display, but may be provided in any useful orientation. FIG. 7 shows an exemplary ICBS trending data results pop-up box 702 that is activated by the trending button and displays current vote tallies for the selected content. FIG. 8 shows an exemplary ICBS expanded details pop-up box 802 showing Truth and BS voting buttons, an entry box for entering comments, citations, annotations or the like related to the content and submit buttons therefor. FIG. 9 shows an exemplary processing icon displayed in the ICBS toolbar upon submission of a vote, comment or the like, where the processing icon appears during submission and disappears upon successful submission of the same to the ICBS server(s) 104. FIG. 10 shows an exemplary Comments pop up box 1002 showing comments submitted in accordance with Truth and BS votes of other users. FIG. 11 shows an exemplary Trending pop up box 1102, showing a heat map index for color (or other graphical) overlays appearing with content and based on voting of all users.

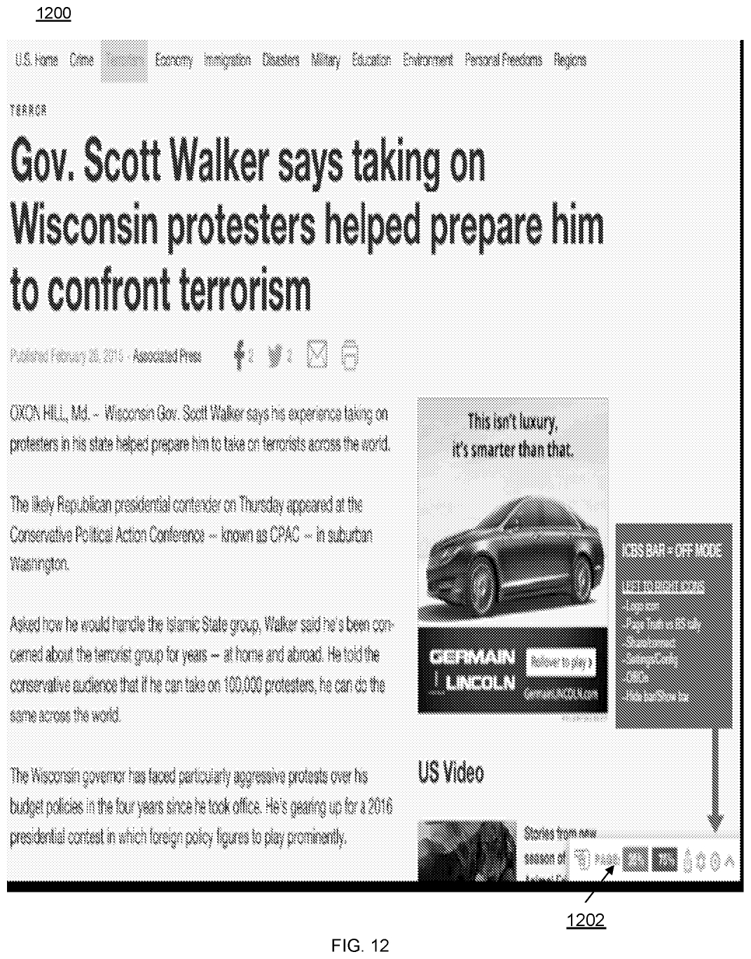

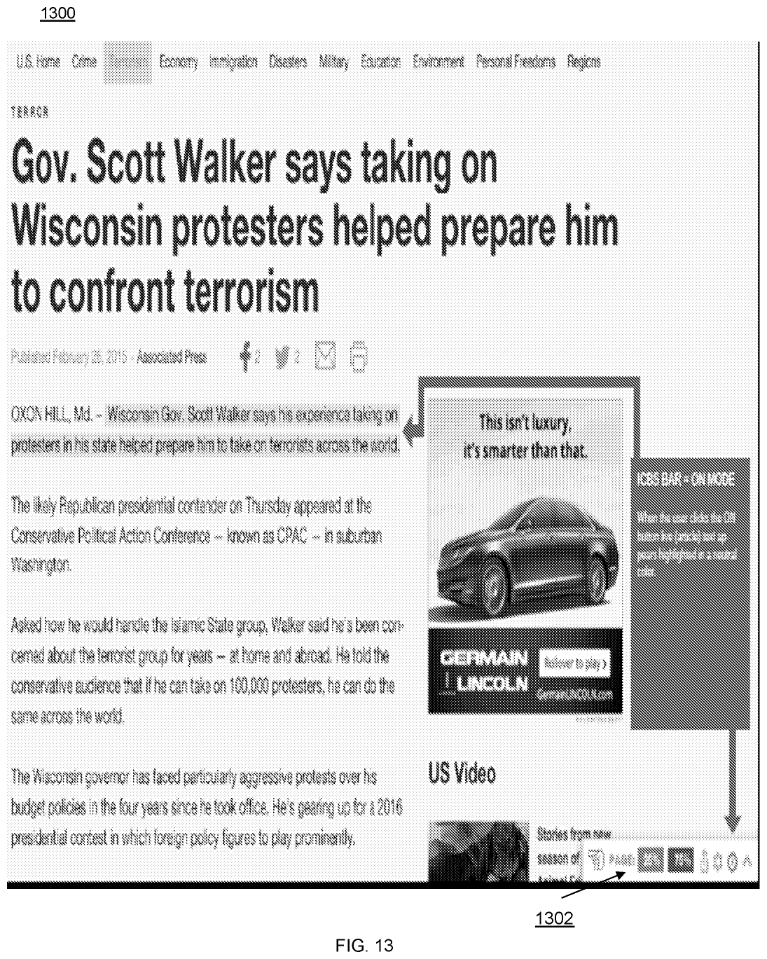

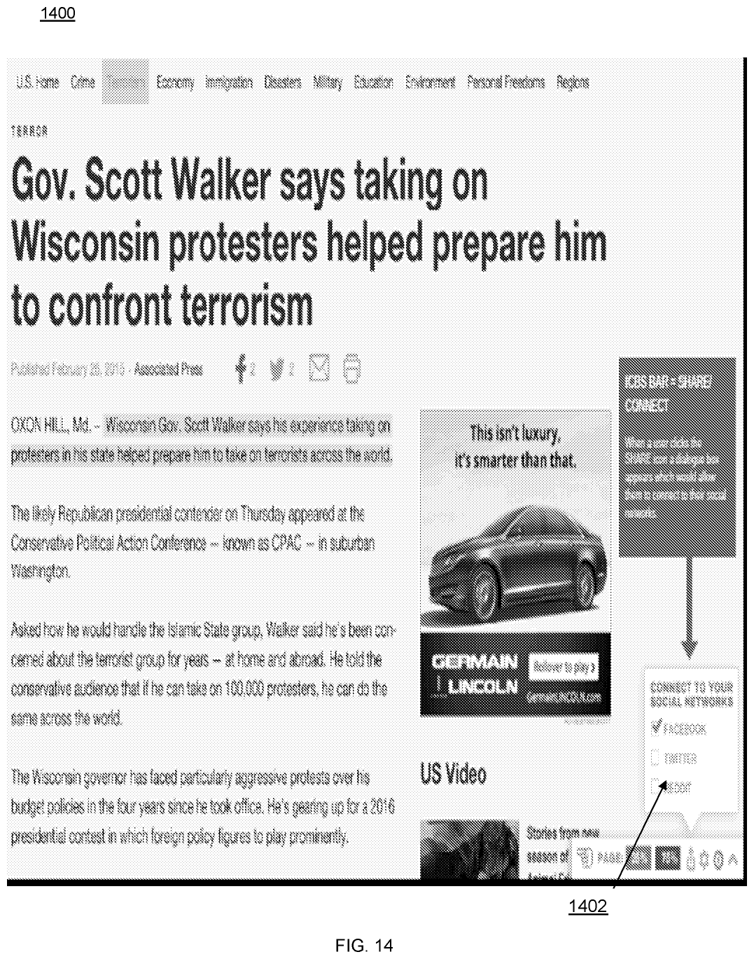

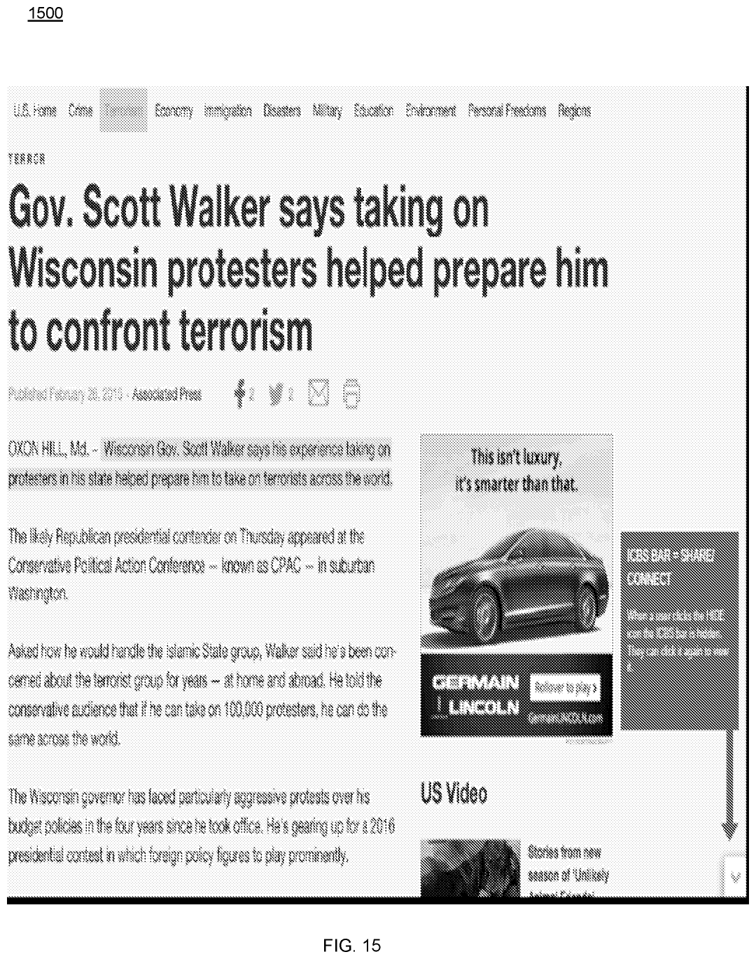

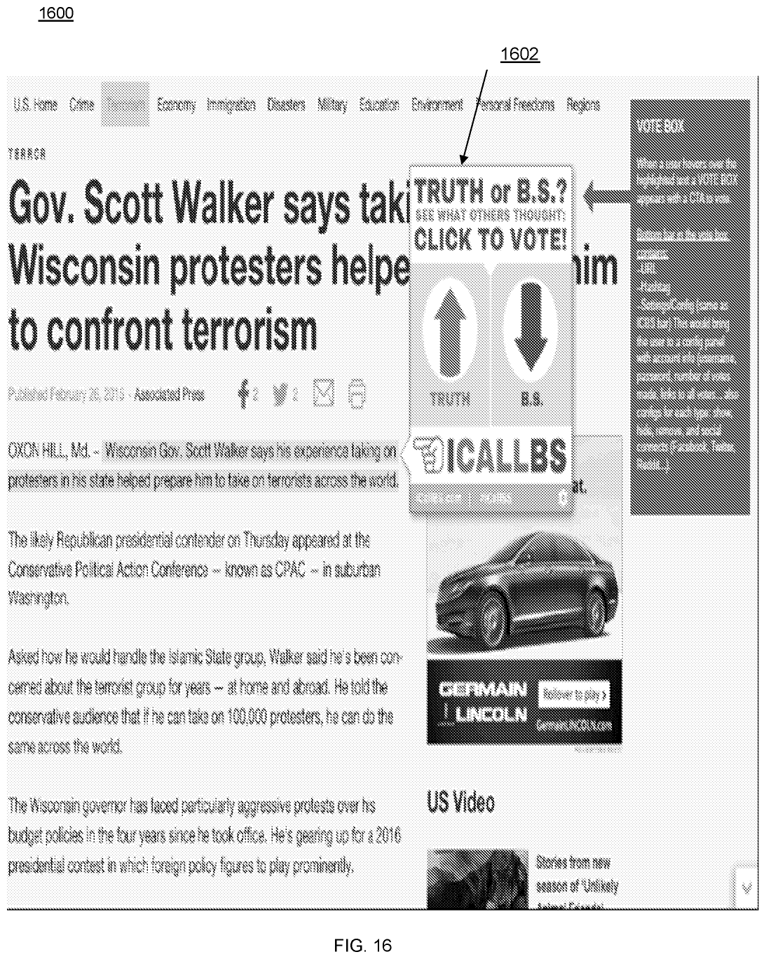

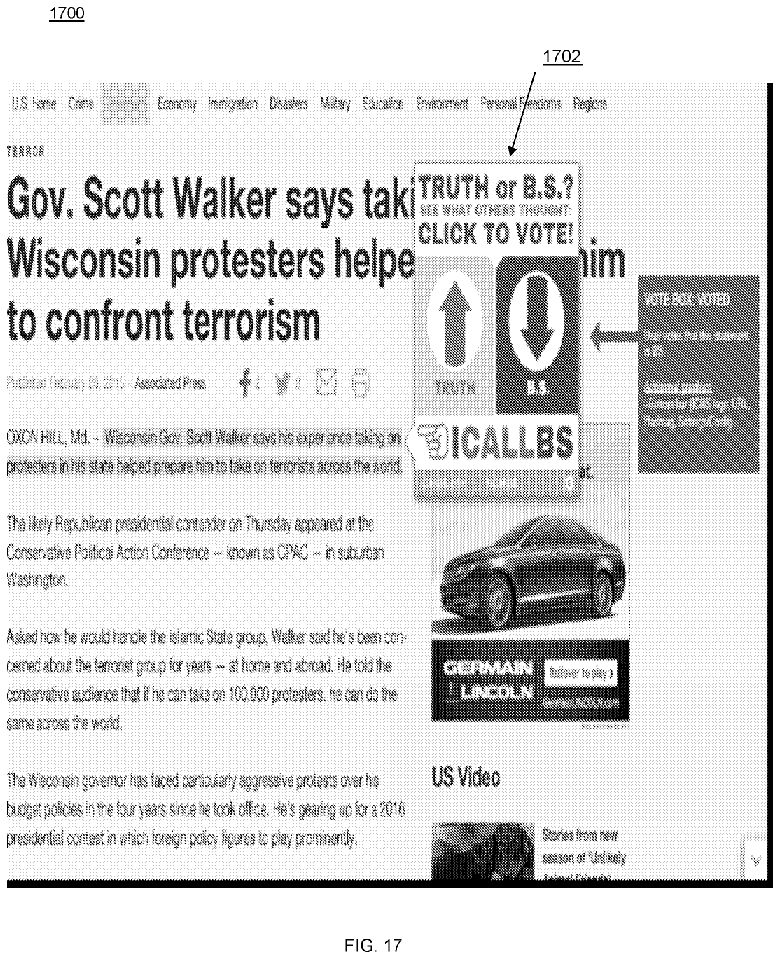

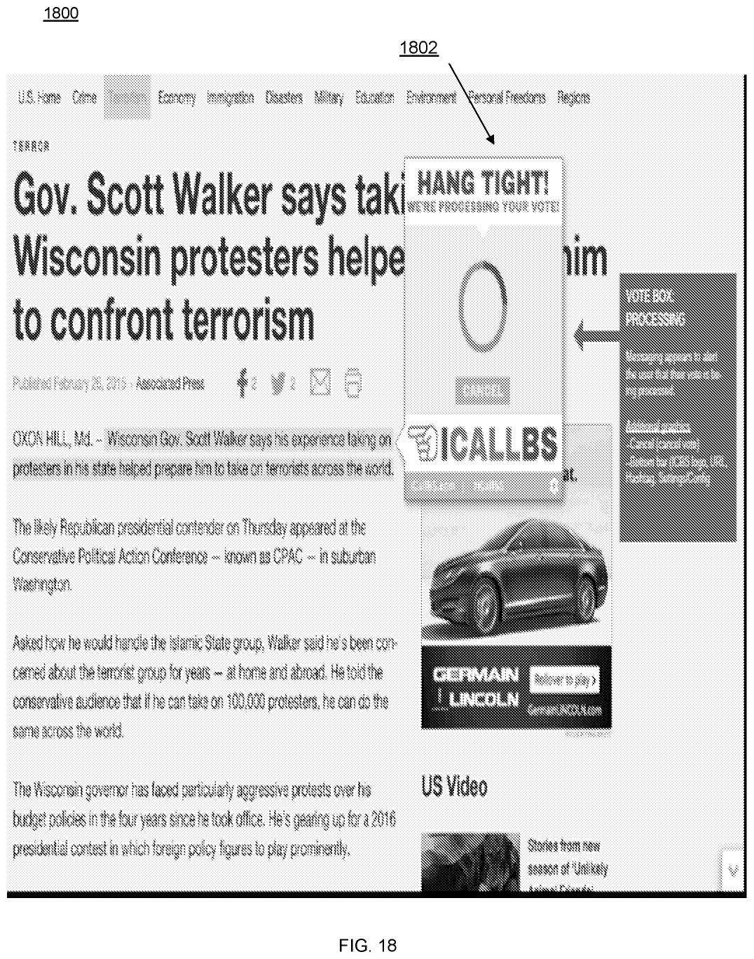

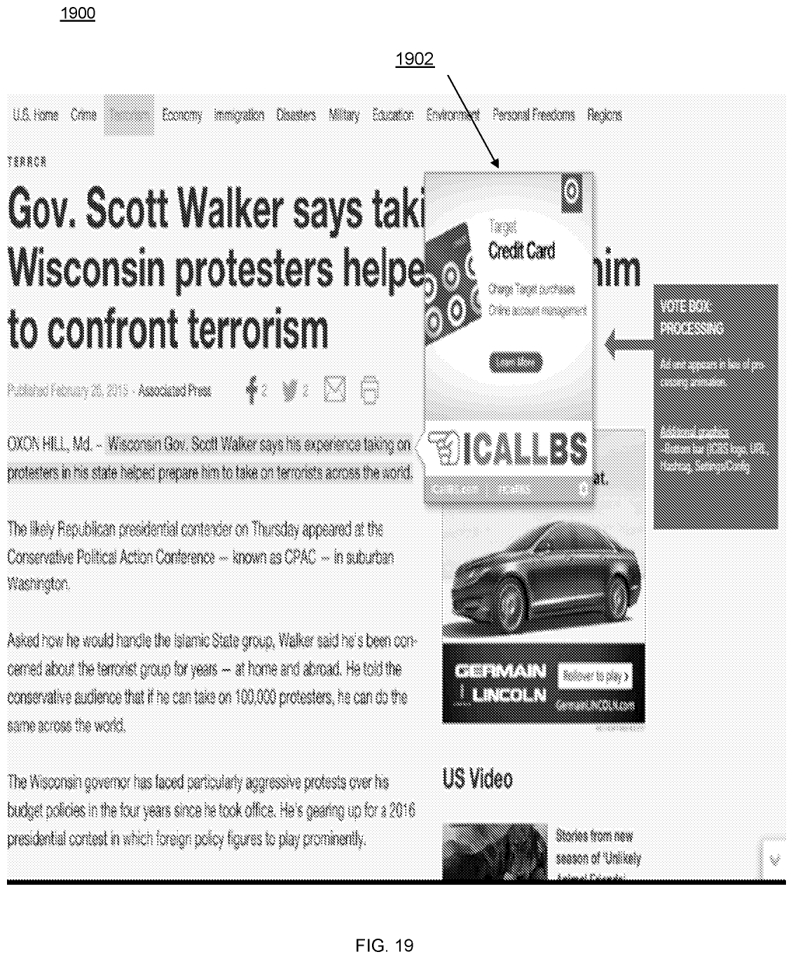

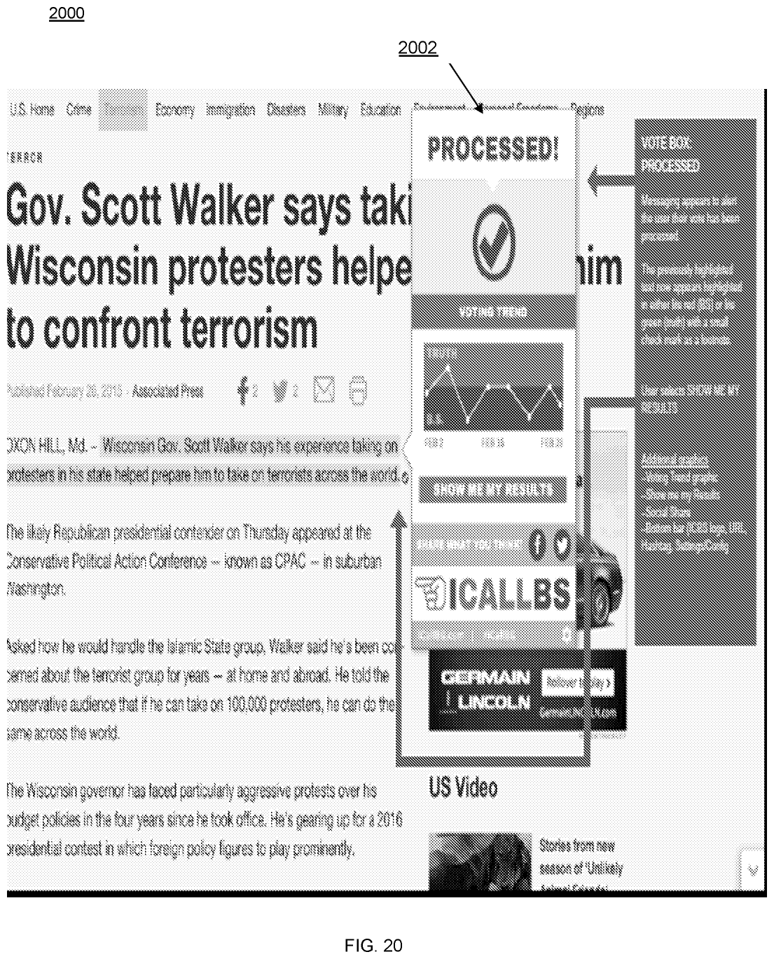

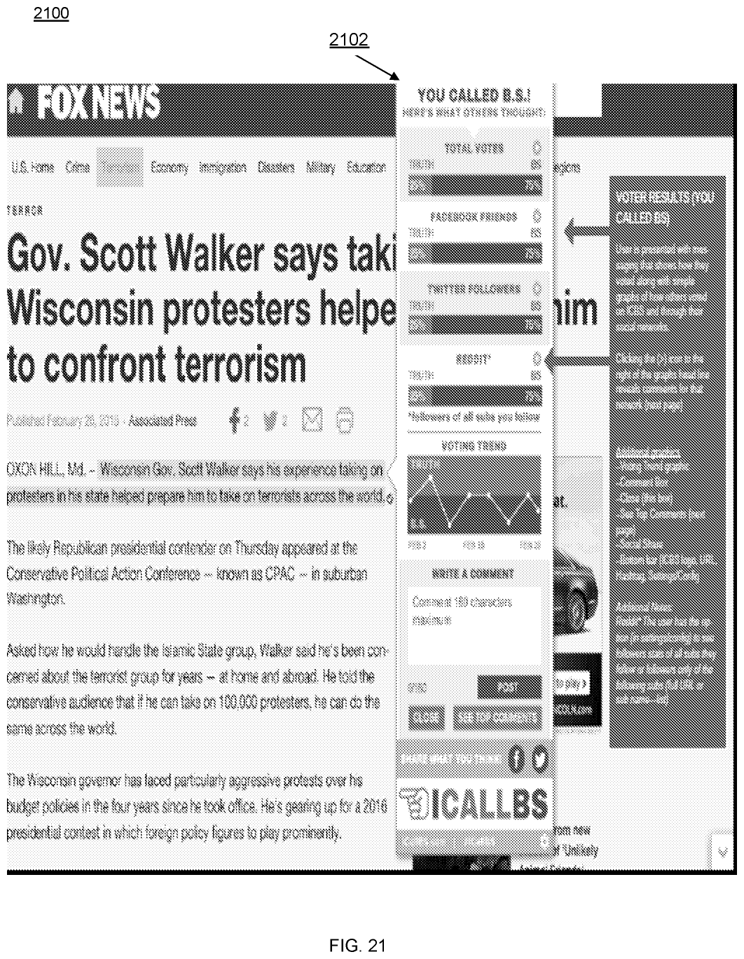

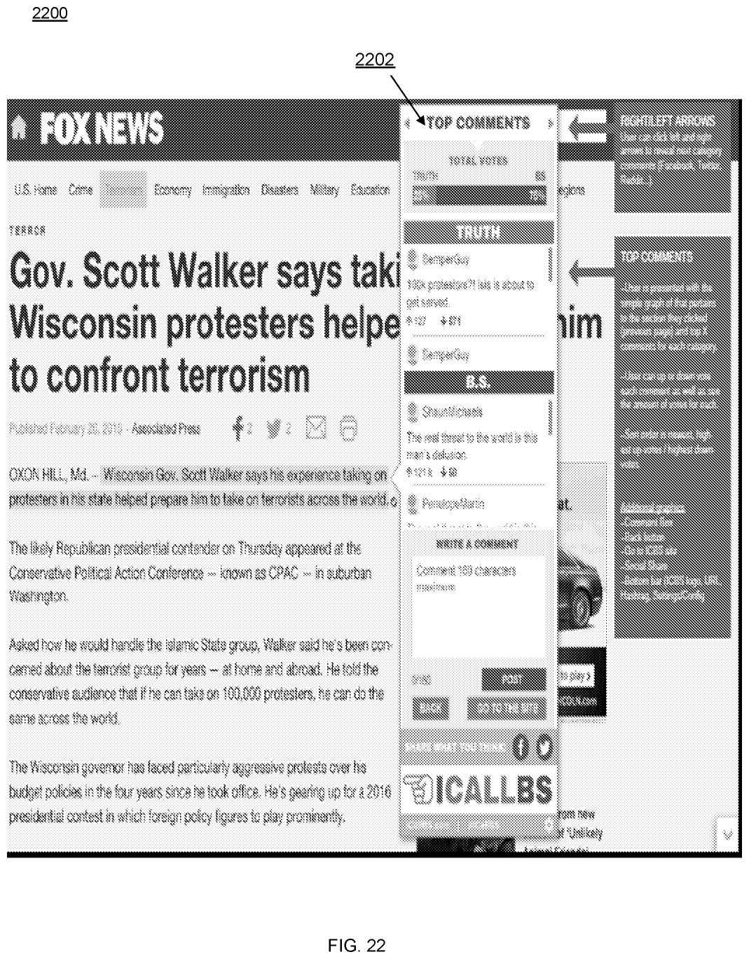

FIG. 12-22 are exemplary displays of second digital content 1200-2200 with ICBS voting and results reporting functionality displayed therewith. FIG. 12 shows an exemplary display of content 1200 with an ICBS toolbar 1202 in off mode with buttons and icons as described in the foregoing. FIG. 13 shows an exemplary display of content 1300 with an ICBS toolbar 1302 in on mode with buttons and icons as described in the foregoing. FIG. 14 shows an exemplary display of content 1400 with an ICBS Connection Pop Up box 1402 showing a connection status with ICBS server(s) 104. FIG. 15 shows an exemplary display of content 1500 with the ICBS toolbar collapsed. FIG. 16 shows an exemplary display of content 1600 with an ICBS Voting Pop Up box 1602 with voting buttons for voting on a veracity of the selected content. In various embodiments, a Setting icon may be included, which upon selection, allows a user to enter a user name, password, contact information, social media account and other profile information of the user, along with details on stored ICBS user activity for the user. FIG. 17 shows an exemplary display of content 1700 with a second exemplary Voting Pop Up box 1702 with an ICBS logo. FIG. 18 shows an exemplary display of content 1800 with an ICBS Process Icon Pop Up box 1802 that is displayed when a vote or content is being submitted to the ICBS server(s) 104. FIG. 19 shows an exemplary display of content 1900 with an Advertising Pop Up box 1902 that may displayed while a user is using the ICBS UI. FIG. 20 shows an exemplary display of content 2000 with a Vote Processed Pop Up box 2002 that confirms vote submission, displays voting trends of other users to a user that submitted a vote on the content 2000. FIG. 21 shows an exemplary display of content 2100 with an ICBS Vote Results Pop Up box 2102 that shows their voting history along with graphics depicting how other users voted, which may be segregated based on type of voter (i.e., the social media platform in which they participate, or other useful categorizations). FIG. 22 shows an exemplary display of content 2200 with an ICBS Comments box 2202 showing comments submitted by other ICBS voters of the content. In various embodiments, the identity of individual voters are withheld and kept private from other ICBS users, though comments and aggregate vote data remain accessible to all.

In order to implement the functionalities described herein, the following processes may be specially programmed into the ICBS server(s) 104.

The following are exemplary steps of an ICBS user registration process for registering new ICBS users.

Create Account (login w/ FB, TW, etc.)
User Submits Email or other unique identifier (i.e. social media account)
   Welcome email dispatched to user address to verify registration
ICBS system will Verify the Email or other user identifier is active and valid
   Account verified
Verify mobile device telephone number if submitted by user (such submission may grant users access to higher level ICBS functions as an upgraded user)
   SMS Reply/Account verified by reply from mobile device
User configures and personalizes account
   Picture of user uploaded (if desired)
   Set ICBS to auto-ost to user's social media accounts (i.e. TWITTER or FACEBOOK)

The following are exemplary steps of an ICBS User Account Features process for verified registered users:

Verification of famous users (celebs, etc.)—apply a green thumbs up avatar or the like to user's profile—designate as “Specialist User” or like
Establish page/channel for user
   Show vote/post history
   Allow followers
      Alert settings (follower setting)
   Show followers/following (either totals or anonymously)
Share link
Troll lockout if too many posts, text or email an unlock code

Specialist Users under this process may have their own channel/page within ICBS that can be followed. The number of followers may affect such user's Login/portal ICBS page, as followed specialists will be added to dashboard. Specialist pages may list their votes on various content and topics. Content channels for verified famous users allow regular users to follow how the famous user voted. Specialists may receive a portion of ICBS ad revenue via their channel in exchange for usage of the ICBS system.

The following are exemplary steps of an ICBS Plug-IN/Mobile App Installation Process enabling ICBS UI features on their user device:
Download Plugin/App from ICBS server(s) 104
Login/Register of User
   Optional but required to vote/call BS
Logged in user
   View of ICBS-enabled dashboard (app only)
   Find new content (user gets ORIGIN point for new content)
      Highlight section (sentence or quote minimum)
      Vote
      Processing (ad)
      Complete
      View results/updates
   Vote on existing content (previously submitted)
      Vote
      Processing (ad)
      Complete
      View results/updates
         On ORIGIN or VOTE, automatically subscribe to that ICBS-let
         Get updates in your daily dashboard on login to site
         Section in app to view dashboard

The following are exemplary steps of an ICBS Content Selection Process enabling ICBS UI voting features on their user device:
Plugin/App installed
User loads content website
Plugin/app pings ICBS Application Programming Interface (API) with content's website address or Uniform Resource Locator (URL):
   If URL has been Originated/flagged, load overlay
   Test sentences within content; if sentence has been Originated/flagged via different URL (syndication, etc); also load overlay. Possibly note that it came from/was originated from a different website
   If plugin installed but off, display icon on plugin bar showing that there is ICBS content within current URL
Does user Originate new content?
   If yes, allow user highlight and vote; send URL, sentence (string), user id, vote, time/date via ICBS API
   On Success, update visual of URL content to reflect user vote (strong green, 1 vote) and user origination (badge/icon/etc.)
Does user vote on existing content?
   If use, allow user vote; send URL, sentence (string), User Identifier (ID), vote, time/date via ICBS API
   On Success, update visual of URL content to reflect user vote (may slightly change shade of overlay based on user vote)
   Add icon to overlay showing that user voted
   On load of Browser, populate with 20-50 popular news Sites. User can also enter URL and add to list of Sites for easy future browsing
   User can use browser to search news, and originate content.

Users originating content, or voting on existing originations can specify a Citation to justify their vote of truth or BS. Citations are the same objects as originated content; a sentence originated from content. An exemplary commenting process is as follows:
User1 votes BS on this sentence: “Climate change is Fake.”
After voting BS, ICBS asks User1 if she would like to quote an existing citation and displays list of previously used citations, OR add a new one.
User1 is presented the list of existing citations, and selects from the list the following:
“The Earth's temperature has increased 5 degrees Celsius over the past 15 years”—www.somescinencewebsite.com
User1's BS vote, and citation are sent via ICBS API and recorded.
   Focus: one of the goals here is to build credibility in citations. A few things can occur here: If a citation is widely used, AND overwhelmingly voted TRUTH, we learn something and that information gets closer to fact. If a citation is widely used but generally voted as BS, we also learn that although accepted as fact by the masses, its BS.

The following are exemplary steps of an ICBS Content Selection Process enabling ICBS UI voting features on their user device (this will be set via user settings panel. Enabled by default. Allow login/acct creating using social media accounts, etc).
Must be built into app and site; on vote of BS, user can post or auto-post to any network with short comment. May be required for all/some users.
Calling BS on TWITTER—generate a re-tweet with the ICBS logo and hashtag
   Also receive tweets from #crowdsourcetruth, #ICBS, or similar to seed the ICBS system. On using that hashtag maybe ICBS may create a temporary account from the social media account to ICBS.

The following are exemplary additional ICBS functions available to registered users via their ICBS enabled user devices:
Ban or suspend users
lock or unlock accounts
Invite users
Manage Admins
Remove accounts

In various embodiments, an ICBS web site portal may include the following Site Functions:
For Content
   Create, Read, Update and Delete (CRUD) categories for each content
   Add live news feeds with content for voting by users
   User ability to add content and/or create categories for content
   Select stories/content for feature placement
   BS or NOT BS feature content
Site
   Live/Maintenance mode

In various embodiments, ICBS may include administrative controls to include design overrides for sites who will add default highlighting to hide ICBS color display (e.g. if site is black with white text, a suitable ICBS design template that looks best will be selected.

In various embodiments, ICBS will include advertisement placement options for display with content and ICBS functions. Advertisers may allocate their advertising to particular voters or to those users that voted a particular way on certain content. A variety of advertisement placement criteria are readily contemplated.

In various embodiments, the ICBS system may provide the following reports to administrators, advertisers or ICBS users:
Total users
   Registrations/time of registration
Usage/activity
Ad revenue actual+projected
App/plugin downloads

In various embodiments, any network sites/content may be marked up by ICBS, providing users have the plugin, use the app, OR the site has ICBS embed code on it.
Color scheme can be changed by an administrator (or automatically) based on the site background and text color of the site.
   ‘Crowdsource This’ function: Let users choose an alternate design theme per site, then use that as default for new users.

In various embodiments, third-party websites can add embed ICBS enabling code onto their site. In this manner, any user surfing that site (with or without an ICBS account and software) can see results of ICBS voting on that site's content, and may be encouraged to join the ICBS system.

In various embodiments, the ICBS system may employ Third Party Site Acquisition functions. For example, any vote for Truth or BS on a new, unique site will trigger a contact to encourage them to put tracking script on their site. Upon acceptance, the acquired third party sites may receive a unique dashboard to view additional statistical information about ICBS users voting on their content

In various embodiments, ICBS may send reports on the day's/hour's (or other granularity) summary of Truth and BS votes (or top rated, etc.) to media or corporations originating the content. Such information may be sent to users too.

In various embodiments, ICBS may use statistical analysis of users and content providers to determine companies that align with certain user viewpoints expressed via ICBS voting via an algorithm for cascading/machine learning. Based on who one agrees with, ICBS may create distinct targets/verticals/′echo chambers' for such users. Users may see those companies agree vs disagree with their overall view to create ‘alignments’—allowing users to additionally vote with their dollars. Company positions can be voluntary and/or determined based on corporate action. In certain embodiments, a survey may be provided with 20-30 alignment questions that a company can answer or can be answered on their behalf. Users can call truth or BS on the submitted alignment too.

In various embodiments, existing CAPTCHA technology can be used to verify all inputs and submission. In various embodiments, functionality such as HYPOTHESIS.IS may be reconfigured to operate with ICBS tools to enter annotations to content as described herein.

In various embodiments, ICBS user profiles may include badges to show degrees of personal verification and evidence of expertise. “I'm here now” and “I Was There” flags, along with on-the-spot photos and video, may be determined and verified by Global Positioning System (offered by) validation of a location of the user's device.

In practice, the heretofore described ICBS system can be expected to acquire a large base of users who rate digital content based on perception or actual knowledge of the content's truth or falsity. The ICBS system may rate authors/publishers of content based on overall truth or BS of their authored content. ICBS will allow propagation of rated content to social networks to increase awareness and deter the spread of false information. Finally, ICBS may facilitate participation of larger names/sponsors (news anchors, bloggers, radio personalities) through new channel, ad revenue possibilities, and the like.

In various additional embodiments, the ICBS system includes further programmed improvements that result in technological improvements including quicker identification of related content and providing crowdsourced truth ratings to related content. For example, an ICBS system plugin provide programming instructions that direct one or more computing devices to scan for related content and matching text during CPU processing downtime to spider websites across the Internet for additional text that substantially matches content being judged on the ICBS system.

In various embodiments, the ICBS system uses an objective basis for determining the location of text on a given website. For example, the ICBS system determines and stores a position of a webpage where text appears using caretindex 2040. In some programming languages, this involves a programming command, such as: “public int CaretIndex {get; set;}.”

This command returns a unique, zero-based insertion position index of a caret in web-based text strings. Getting this property returns the current insertion position index of the caret
(see TextPointer for information on terminology like “insertion position”). Setting this property moves the caret to the specified insertion position. An insertion position is between either characters or element tags.

In various embodiments, the ICBS system advantageously employs hashing algorithms applied to text content and using hashes to search loaded webpages for matching content, via a browser or Plugin. Some common hashing algorithms include MD5, SHA-1, SHA-2, NTLM, and LANMAN. When hashing textual content, errors may arise where punctuation and spacings are employed inconsistently on differing websites for otherwise identical text. Using hashing algorithms that are refined to ignore all punctuation and spacing ensures that related text can be found more consistently across multiple sites on the Internet and that the ICBS system can provide truth rankings more quickly to such alternate sites where related content exists.

In various embodiments, the ICBS system includes a citation function, where for textual content being judged, one or more sources that provide independent factual sources are identified to the users. These may include news, history, encyclopedic and other like reference materials.

In various embodiments, the ICBS system includes programming to automatically determine a ‘truth value’ of a quote based on truth values of the citations. For example, content with a truth value of 100/100, citing 2 claims also 100/100 would be identified as 100% truthful and the content color coded dark green, for example. Should one of the supporting sources drop to 50/100 a new truth value of initial cited claim is now (250/300)=83.3% and the color of the content updated accordingly. One of ordinary skill in the art will appreciate that multiple ways to exist to calculate and update truth values based on assessments of the citations relied upon.

Finally, in various embodiments, the ICBS system may improve truth determinations by determining a metric for ICBS users based on how many followers vote the same way as they do (e.g. 92% of followers agree). For example, an initial user votes on a claim, and then several users votes follow. Real time metrics are employed to determine how many users agree with him, including, importantly, those who have agreed with him on earlier claims.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A method for determining an accuracy of content having an address on a computer network, comprising:
providing a user interface for viewing the content to a plurality of users on a plurality of user devices via the computer network, the user interface allowing the users to identify separate portions of the content and to enter a veracity of the separate portions of the content;
receiving, from the user devices, an identification of a portion of the content from a first website;
receiving, from the user devices, indications of the veracity of the portion of the content;
allowing each of the plurality of users to provide an indication of the accuracy of the portion of the content only once, where if any user submits a first indication and a second indication, then the first indication is revised and the second indication is retained;
determining an accuracy of the portion of the content based on the indications;
displaying a text summary of the accuracy of the portion of the content in the user interface based on the indications;
displaying a graphical indication of the accuracy of the portion of the content in the user interface, where the graphical indication comprises a shade of a color that is applied to the portion of the content, the color is selected from at least two colors based on the accuracy, and the shade is selected based on the indications of the veracity of the portion of the content as received from the user devices;
identifying, using a hashing algorithm, an additional instance of the portion of the content on a second website, and displaying the graphical indication of the accuracy of the portion of the content on the second website.
